(19) United States
(12) Patent Application Publication
(10) Pub. No.: US 2021/0067009 A1
(43) Pub. Date: Mar. 4, 2021

(54) ELECTRIC MOTOR POSITIONING DEVICE, ELECTRIC MOTOR, AND GIMBAL

(71) Applicant: SZ DJI TECHNOLOGY CO., LTD., Shenzhen (CN)

(72) Inventors: Sicong LIU, Shenzhen (CN); Jiabin YAN, Shenzhen (CN); Zihan CHEN, Shenzhen (CN); Xifeng ZHAO, Shenzhen (CN)

(21) Appl. No.: 17/081,426

(22) Filed: Oct. 27, 2020

Related U.S. Application Data
(63) Continuation of application No. PCT/CN2018/093887, filed on Jun. 30, 2018.

(51) Int. Cl. H02K 11/22; H02K 11/215; H02K 11/33; H02K 21/16

(52) U.S. Cl. CPC H02K 11/22; H02K 11/215; H02K 2211/03; H02K 21/16; H02K 11/33

(57) ABSTRACT

An electric motor positioning device for an electric motor includes a photoelectric sensor and a positioning ring. The positioning ring includes a first area and a second area. The electric motor includes a rotor and a stator. The rotor is rotatably mounted on the stator. One of the photoelectric sensor and the positioning ring is fixed on the rotor and rotates with the rotor, and the other one of the photoelectric sensor and the positioning ring is fixed on the stator. A position of the photoelectric sensor relative to the positioning ring rotates within a predetermined range with a relative rotation between the rotor and the stator, and the predetermined range includes a boundary between a first area and a second area.

### CROSS-REFERENCE TO RELATED APPLICATION

This disclosure is a continuation of PCT Patent Application No. PCT/CN2018/093887, filed on Jun. 30, 2018, the entire content of which is incorporated herein by reference.

### TECHNICAL FIELD

The present disclosure relates to the technical field of electric motors and, in particular, relates to an electric motor positioning device, an electric motor and a gimbal.

### BACKGROUND

Existing gimbals generally need to control the internal electric motors through advanced electric motor control algorithms to achieve accurate gimbal axis rotation control. One of the premises of the calculation is to obtain the initial position of an electric motor. Under current gimbal control methods, the initial position of the electric motor is obtained through cooperation with the mechanical limit structure of the gimbal. Specifically, the gimbal usually determines the initial position of the gimbal through the known limit position when the gimbal starts and the electric motor rotates forward and backward to hit the limit position. Thus, starting this type of gimbal requires an initial rotation process, the start speed is slow, and the frequently hitting the limit position may cause abrasion to the structure of the gimbal which results in a decrease in the service life of the gimbal.

### SUMMARY

According to one aspect of the present disclosure, an electric motor positioning device for an electric motor is provided. The electric motor positioning device includes a photoelectric sensor and a positioning ring. The positioning ring includes a first area and a second area. The electric motor includes a rotor and a stator. The rotor is rotatably mounted on the stator. One of the photoelectric sensor and the positioning ring is fixed on the rotor and rotates with the rotor, and the other one of the photoelectric sensor and the positioning ring is fixed on the stator. A position of the photoelectric sensor relative to the positioning ring rotates within a predetermined range with a relative rotation between the rotor and the stator, and the predetermined range includes a boundary between a first area and a second area.

According to another aspect of the present disclosure, an electric motor is provided. The electric motor includes a stator, a rotor rotatably mounted on the stator, a controller and an electric motor positioning device. The electric motor positioning device includes a photoelectric sensor electrically connected to the controller and a positioning ring. The controller is configured to obtain an electrical signal of the photoelectric sensor. The positioning ring includes a first area and a second area. One of the photoelectric sensor and the positioning ring is fixed on the rotor and rotates with the rotor, and the other one of the photoelectric sensor and the positioning ring is fixed on the stator. A position of the photoelectric sensor relative to the positioning ring rotates within a predetermined range with a relative rotation between the rotor and the stator, and the predetermined range includes a boundary between a first area and a second area.

According to further aspect of the present disclosure, a gimbal is provided. The gimbal includes at least one gimbal shaft. The gimbal shaft includes an electric motor configured to drive the gimbal shaft to rotate. The electric motor includes a stator, a rotor rotatably mounted on the stator, a controller and an electric motor positioning device. The electric motor positioning device includes a photoelectric sensor electrically connected to the controller and a positioning ring. The controller is configured to obtain an electrical signal of the photoelectric sensor. The positioning ring includes a first area and a second area. One of the photoelectric sensor and the positioning ring is fixed on the rotor and rotates with the rotor, and the other one of the photoelectric sensor and the positioning ring is fixed on the stator. A position of the photoelectric sensor relative to the positioning ring rotates within a predetermined range with a relative rotation between the rotor and the stator, and the predetermined range includes a boundary between a first area and a second area.

### BRIEF DESCRIPTION OF THE DRAWINGS

In order to more clearly describe the technical solutions in the embodiments of the present disclosure or the existing technology, the following will briefly introduce the drawings for the description of the embodiments. Apparently, the drawings in the following description are only some embodiments of the present disclosure. For those of ordinary skill in the art, other drawings can be obtained based on these drawings without creative efforts.

FIG. 1 is a schematic structural diagram of an electric motor in a first direction according to an embodiment of the present disclosure;

FIG. 2 is a schematic structural diagram of the electric motor according to FIG. 1 in a second direction opposite the first direction;

FIG. 3 illustrates a schematic cross-sectional view of the electric motor according an embodiment of the present disclosure; and

FIG. 4 is a schematic structural diagram of the electric motor in the first direction according to another embodiment of the disclosure.

### DETAILED DESCRIPTION

The technical solutions in the embodiments of the present disclosure will be described below in conjunction with the drawings. Apparently, the described embodiments are only some embodiments of the present disclosure, rather than all of the embodiments. Based on the described embodiments of the present disclosure, other embodiments obtained by those of ordinary skill in the art without creative efforts shall fall within the scope of the disclosure.

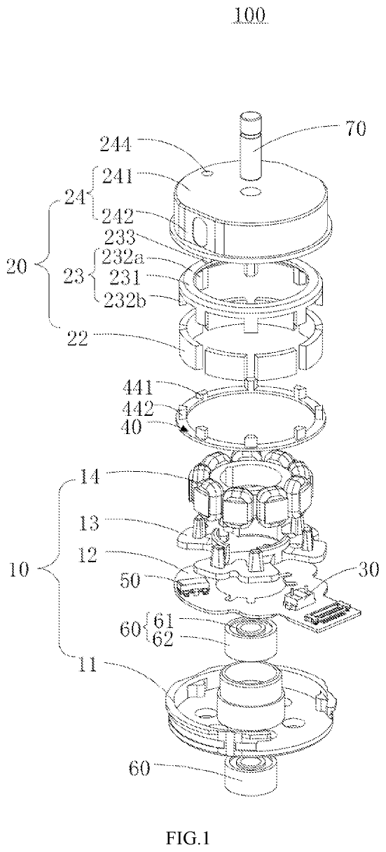

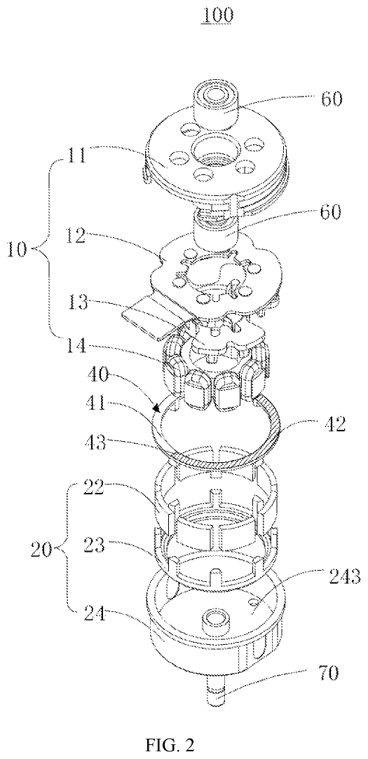

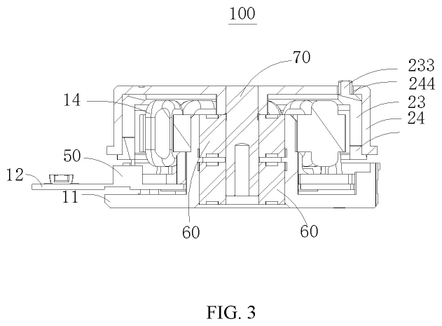

Referring to FIGS. 1 to 3, the present disclosure provides an electric motor 100. The electric motor 100 includes a stator 10, a rotor 20, a Hall sensor 30, and an electric motor positioning device. Other components may also be included.

The electric motor positioning device is used in an electric motor. The rotor is rotatably mounted on the stator, that is, the rotor is mounted on the stator and rotates relative to the stator. Referring to FIG. 1, in an embodiment of the present disclosure, the electric motor positioning device includes a positioning ring 40 and a photoelectric sensor 50. One of the photoelectric sensor 50 and the positioning ring 40 is fixed on the rotor and rotates with the rotor, and the other is fixed on the stator, so that the positioning ring 40 rotates relative to the photoelectric sensor 50. Specifically, the photoelectric sensor 50 is fixed on the stator, and the positioning ring 40 is disposed on the rotor and rotates coaxially with the rotor; or, the photoelectric sensor 50 is fixed on the rotor and rotates with the rotor, and the positioning ring 40 is disposed on the stator. When the rotor rotates relative to the stator, the photoelectric sensor 50 rotates relative to the positioning ring 40. In this embodiment, the positioning ring 40 is disposed on the rotor, and the photoelectric sensor 50 is disposed on the stator.

The positioning ring 40 includes a first area 41 and a second area 42, and there is a boundary 43 between the first area 41 and the second area 42. In some embodiments, a light reflectivity of the first area 41 and a light reflectivity of the second area 42 are different. In certain other embodiments, the light transmittance of the first area 41 and the light transmittance of the second area 42 are different. In some embodiments, the positioning ring 40 only has the first area 41 and the second area 42, the light reflectivity of the first area 41 is greater than the light reflectivity of the second area 42, and the first area 41 and the second area 42 are symmetrically arranged on the positioning ring 40. Specifically, in an embodiment, the first area 41 is located within a range of 0°-180° of the positioning ring 40, and the second area 42 is located within a range of 180°-360° of the positioning ring 40. It can be understood that in certain other embodiments of the present disclosure, the positioning ring 40 may also include three or more areas, for example, may also include a third area. In addition, each of the areas (including the first area 41, the second area 42 and other areas) may be unevenly distributed on the positioning ring 40. For example, the first area 41 may be located in the range of 0°-90° of the positioning ring 40, and the second area 42 may be located in the range of 90°-360° of the positioning ring 40.

In the present disclosure, the relative position of the photoelectric sensor 50 and the positioning ring 40 rotates within a predetermined range along with the rotor and the stator of the motor, and the predetermined range includes a boundary area of the first area 41 and the second area 42. Specifically, the controller 80 controls the rotor to rotate relative to the stator. The relative rotation between the rotor and the stator drives the photoelectric sensor 50 to rotate relative to the positioning ring 40. The predetermined range indicates that the motor can only rotate within a limited range but cannot achieve 360° omnidirectional rotation.

For example, in some cases, the structure driven by the motor may have an external limit so that the structure cannot rotate 360° As a result, the motor cannot rotate 360°, but can only rotate within a predetermined range. In other cases, the motor cannot achieve 360° rotation due to its own control and will not be limited here. The predetermined range includes a boundary 43 between the first area 41 and the second area 42. When the photoelectric sensor 50 corresponds to the boundary 43, the motor is in an initial position. In some cases, the predetermined range includes one and only one boundary 43, so that the position of the motor corresponding to the boundary 43 within the predetermined range can be uniquely determined.

In some embodiments, the photoelectric sensor 50 includes a light emitting module and a light receiving module, the light emitting module and the light receiving module are arranged at the same side with the positioning ring, and the light reflectivity of the first area 41 is different from the light reflectivity of the second area 42. The light emitting module is configured to emit light signal to the positioning ring 40, and the light receiving module is configured to receive the light signal reflected by the positioning ring 40 and output corresponding electrical signal to the controller to determine the position of the electric motor 100. In an embodiment, the electrical signal output by the light receiving module of the photoelectric sensor 50 corresponding to the first area 41 and the electrical signal output by the light receiving module of the photoelectric sensor corresponding to the second area 42 are voltages of different magnitudes. For example, when the light reflectivity of the first area 41 is greater than the light reflectivity of the second area 42, the light emitting module of the photoelectric sensor 50 sends a light signal to the positioning ring 40. When the light signal sent by the light emitting module of the photoelectric sensor 50 irradiates the first area 41 of the positioning ring 40, most of the light signal is reflected by the first area 41, so that the light receiving module receives stronger light signals and further outputs a larger first voltage. When the light signal sent by the light emitting module irradiates the second area 42 of the positioning ring 40, most of the light signal is absorbed by the second area 42, and only a very small amount of it is reflected, so that the light receiving module receives weak signal and then outputs a smaller second voltage. Accordingly, it can be determined whether the photoelectric sensor 50 corresponds to the first area 41 or the second area 42 from the magnitude of the output voltage, and the obtained area information can be sent to the controller. Therefore, when the motor rotates from the photoelectric sensor 50 corresponding to the first area 41 to the position of the boundary 43, and when the photoelectric sensor 50 rotates to the position corresponding to the boundary 43, the output voltage can drop. That is, the output voltage drops from the first voltage to the second voltage. At this time, it can be determined that the photoelectric sensor 50 corresponds to the position of the boundary 43.

Further, a reflective material may be coated on the first area 41 to further increase the light reflectivity of the first area 41, to make a difference between the output voltage of the photoelectric sensor 50 corresponding to the first area 41 and the output voltage corresponding to the second area 42 more obvious, so that it can be easier to determine whether the photoelectric sensor 50 corresponds to the first area 41 or the second area 42.

In certain other embodiments, the light emitting module and the light receiving module are arranged on both sides of the positioning ring, and the light transmittance of the first area 41 and the light transmittance of the second area 42 are different. The light emitted by the light emitting module passes through the positioning ring 40 and is accommodated by the light receiving module. According to the difference between the light transmittance of the first area 41 and the light transmittance of the second area 42, when the photoelectric sensor 50 corresponds to different positions of the positioning ring 40, the light receiving module receives different light intensity to output different electrical signals, to determine the position of the electrode motor 100. The specific process of determining the position of the electric motor 100 is similar to the foregoing embodiment and will not be repeated here. It can be appreciated that the light transmittance of the first area 41 and the light transmittance of the second area 42 are different, which may include that a material of the first area 41 is different from a material of the second area 42, or one of the first area 41 and the second area 42 is a through hole or a hollow; or one of the first area 41 and the second area 42 includes a spaced through hole structure, such as a photoelectric code wheel.

According to some embodiments, referring to FIGS. 1-3, the rotor 20 rotates relative to the stator 10. In an embodiment, the positioning ring 40 is fixed on the rotor 20 and the photoelectric sensor 50 is fixed on the stator 10. It can be appreciated that in certain other embodiments of the present disclosure, the positioning ring 40 may also be fixed on the stator 10 and the photoelectric sensor 50 is fixed on the rotor 20. In the present disclosure, the positioning ring 40 is fixed to the stator, and the photoelectric sensor 50 is fixed to the rotor. When the photoelectric sensor 50 is facing the boundary of the positioning ring 40, the position of the motor is the initial position, that is, when the stator 10 and the rotor 20 rotates until the photoelectric sensor 50 is exactly opposite the boundary 43 between the first area 41 and the second area 42, the electric motor 100 is in the initial position.

The electric motor 100 senses whether the photoelectric sensor 50 corresponds to the first area 41 or the second area 42 through the photoelectric sensor 50 and the positioning ring 40 respectively arranged on the stator 10 and the rotor 20, and send the obtained area information to the controller. The controller uses the area information to control the rotor 20 to rotate in a certain direction and the photoelectric sensor 50 rotates to the position of the boundary 43 and the rotor 20 rotates until the photoelectric sensor 50 corresponds to the boundary 43 to determine the initial position of the electric motor 100. Compared with the existing technology, the motor 100 of the present disclosure is not required to be provided with a limiting structure, has a simple structure, and can obtain the initial position of the electric motor 100 simply and quickly.

In an embodiment of the present disclosure, the rotor 20 includes a rotor end cover 21, a rotor magnet 22 and a magnet holder 23. The rotor magnet 22 is fixed on the magnet holder 23, and the positioning ring 40 is fixed on the magnet holder 23. The magnet holder 23 is provided with a first positioning member, and the positioning ring 40 is provided with a second positioning member corresponding to the first positioning member, so that the positioning ring 40 is assembled to a rotor end cover 21 and can be easily positioned on 21, thereby ensuring that the boundary of the positioning ring 40 can correspond to the initial position of the electric motor 100. The rotor magnet 22 is a permanent magnet. The rotor magnet 22 may be a block magnet or a ring magnet.

In some embodiments, the rotor end cover 21 includes a top wall 211 and a side wall 212 surrounding the periphery of the top wall 211. The top wall 211 and the side wall 212 form a receiving cavity 213, and the rotor magnet 22 is accommodated in the receiving cavity 213.

In some embodiments, the magnet holder 23 includes a fixed ring 231 and a first convex post 232a arranged on the edge of the fixed ring 231 and perpendicular to the plane of the fixed ring 231. The first convex post 232a is the first positioning member; the positioning ring 40 is provided with a second protrusion 441 perpendicular to a plane of the positioning ring 40, and the second protrusion 441 is the second positioning member. The second convex post 441 is opposite and fixed to the first convex post 232a, so that the positioning ring 40 is disposed on the rotor 20 through the relatively fixed arrangement of the first convex post 232a and the second convex post 441 and the boundary 43 corresponds to the initial position of the electric motor 100, that is, when the photoelectric sensor 50 corresponds to the boundary 43, the motor 100 is in the initial position.

Further, the peripheral edge of the fixed ring 231 is also provided with a plurality of spaced third protrusions 232b perpendicular to a plane of the fixed ring 231, and a height of the third protrusions 232b is smaller than a height of the first protrusions 232a. The positioning ring 40 is also provided with a plurality of spaced fourth protrusions 442 perpendicular to the plane of the positioning ring 40, a height of the fourth protrusions 442 is greater than a height of the second protrusion 441, and the fourth protrusion 442 corresponds to the third protrusion 232b. The sum of the height of the fourth protrusion 442 and the third protrusion 232b is the same as that of the first protrusion 232a and the second protrusion 441. Through the fourth convex post 442 and the third convex post 232b, and the first convex post 232a and the second convex post 441, each position of the positioning ring 40 is stably supported by the magnet holder 23. Moreover, by arranging the second protruding post 232b and the fourth protruding post 442, and fixing the positioning ring 40 on the magnet holder 23, the second protruding post 232b and the fourth protrusion 442 can be fixed, so that the positioning of the positioning ring 40 on the magnet holder 23 can be easily achieved and when the photoelectric sensor 50 corresponds to the boundary 43, the motor 100 is in the initial position.

Further, in some embodiments, there are a plurality of the rotor magnets 22, and each of the rotor magnets 22 is arranged between two adjacent protrusions 232. The sum of the height of the second protrusion 232b and the height of the fourth protrusion 442 is the same as the height of the rotor magnet 22, so that each of the rotor magnets 22 can be clamped between the positioning ring 40 and the magnet holder 23 to keep the rotor magnet 22 stable.

In some embodiments, the positioning ring 40 may be fixed to the magnet holder 23 by means of glue or may be fixed on the magnet holder 23 by means of screw, snap-fit, or the like. The rotor magnet 22 may also be fixed to the magnet holder 23 by means of glue or other fixing structures.

In certain other embodiments of the present disclosure, the magnet holder 23 may have a structure including a top wall and a side wall surrounding a periphery of the top wall. The top wall and the side wall form a receiving cavity, and the rotor magnet 22 is accommodated in the receiving cavity. The positioning ring 40 is fixed to an end of the side wall of the magnet holder 23 facing away from the top wall. An end of the side wall facing away from the top wall is provided with a groove, and the groove is the first positioning member. The positioning ring 40 is provided with a protrusion corresponding to the groove, and the protrusion is the second positioning member. When the positioning ring 40 is fixed on the side wall, the protrusion is inserted into the groove.

It can be appreciated that in some embodiments of the present disclosure, the positioning ring 40 and the magnet holder 23 may be integrally formed. In other words, the positioning ring 40 and the magnet holder 23 may be an integral structure.

Further, in some embodiments of the present disclosure, the rotor 20 further includes a rotor end cover 24, and the rotor end cover 24 includes a top wall 241 and a side wall 242 surrounding a periphery of the top wall 241. The top wall 241 and the side wall 242 form a receiving cavity 243, and the rotor magnet 22 and the magnet holder 23 are accommodated in the receiving cavity 243. In addition, a positioning hole 244 is provided on the rotor end cover 24, and a protrusion 233 corresponding to the positioning hole 244 is provided on the magnet holder 23. When the rotor magnet 22 and the magnet holder 23 are accommodated in the receiving cavity 243, the protrusion 233 is inserted into the positioning hole 244 to implement the disposition of the magnet holder 23 within the rotor end cover 24. It can be appreciated that in some embodiments of the present disclosure, the magnet holder 23 and the rotor end cover 24 can be integrally formed. In other words, the magnet holder 23 and the rotor end cover 24 form an integrated structure, and the first area 41 and the second area 142 is formed on an end surface of the integrated structure corresponding to the photoelectric sensor 50, and the boundary between the first area 41 and the second area 42 is the boundary 43.

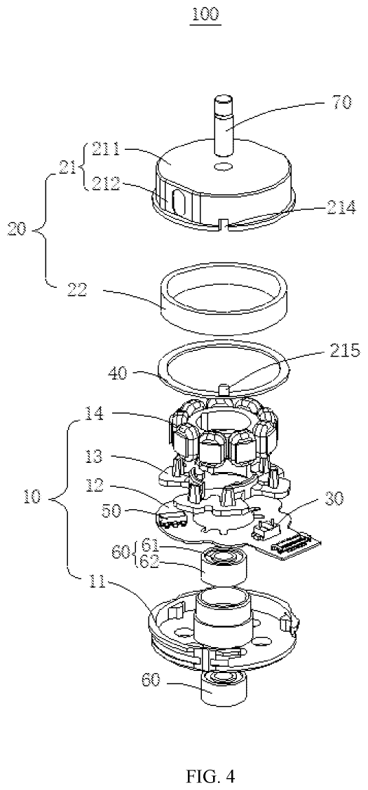

Referring to FIG. 4, in another embodiment of the present disclosure, the rotor 20 includes the rotor end cover 21 and the rotor magnet 22 described in the embodiment of FIG. 1. In other words, the difference between the rotor 20 shown in FIG. 1 and the rotor 20 shown in FIG. 4 includes that in FIG. 4, the magnet holder 23 is not included in the rotor 20, and the rotor magnet 22 is directly fixed within the rotor end cover 21. The positioning ring 30 is also directly fixed on the rotor end cover 21. The rotor end cover 21 includes the top wall 211 and the side wall 212 surrounding the periphery of the top wall 211. The top wall 211 and the side wall 212 form the receiving cavity 213, and the rotor magnet 22 is accommodated in the receiving cavity 213.

In one embodiment, the top wall 211 is circular, and the receiving cavity 213 is cylindrical. The rotor magnet 22 is a permanent magnet. The rotor magnet 22 may be a block magnet or a ring magnet. In some embodiments, the rotor magnet 22 is a ring magnet, and its outer side wall is fixed to the side wall 212 of the rotor end cover.

In one embodiment, the positioning ring 40 is fixed on an end surface of the side wall 212 of the rotor end cover 21 away from the top wall 211. It can be appreciated that the positioning ring 40 may also be fixed to an inner surface of the side wall 212 surrounding the receiving cavity 213. In addition, the first positioning member 214 is disposed at the end surface of the side wall 212 of the rotor end cover 21 away from the top wall 211, and the second positioning member 215 is disposed at the positioning ring 40. The second positioning member 215 is arranged corresponding to the first positioning member 214, so that when the positioning ring 40 is assembled on the rotor end cover 21, the boundary 43 of the positioning ring 40 can correspond to the initial position of the electric motor 100. In one embodiment, a protrusion is disposed at the positioning ring 40, and the protrusion is the second positioning member; a groove is disposed at the rotor end cover 21, and the groove is the first positioning member 214. When the positioning ring 40 is assembled on the rotor end cover 21, the protrusion is inserted into the groove. It can be appreciated that in the present disclosure, the positioning ring 40 may be integrally formed with the side wall 212 of the rotor end cover 21. In other words, the rotor end cover 21 and the positioning ring 40 form an integral structure, and the first area 41 and the second area 42 are formed on an end surface of the integral structure corresponding to the photoelectric sensor 50, and the boundary between the first area 41 and the second area 42 is the boundary 43.

Returning to FIG. 1, the stator 10 includes a stator base 11, a drive circuit board 12, a drive board pressing piece 13 and one or more coil windings 14. In one embodiment, there are a plurality of the coil windings 14, the plurality of coil windings 14 are wrapped in a ring shape, the coil windings 14 are arranged in a ring surrounded by a plurality of rotor magnets 22, and there is a gap between the adjacent rotor magnets 22. In other words, the ring surrounded by the plurality of rotor magnets 22 is sleeved on an outer circumference of the ring surrounded by the plurality of coil windings 14, and is coaxially arranged with the ring surrounded by the plurality of coil windings 14. By controlling the amount of electricity flowing into the coil winding 14, an electromagnetic driving force is generated between the stator 10 and the rotor 20, so that the rotor 20 rotates relative to the stator 10. The coil winding 14 is electrically connected to the driving circuit board 12, so that the amount of electricity flowing into the coil winding 14 can be controlled by the driving circuit board 12. In one embodiment, the one or more coil windings 14 are fixed on the drive board pressing piece 13 and fixed on the drive circuit board 12 through the drive board pressing piece 13. The drive board pressing piece 13 is made of insulating material, and the coil winding 14 is separated from the drive circuit board 12 by the drive board pressing piece 13. Further, the Hall sensor 30 and the photoelectric sensor 50 are both arranged on the drive circuit board 12 and electrically connected to the drive circuit board 12, and the signal generated by Hall sensor 30 and the photoelectric sensor 50 is transmitted through the drive circuit board 12. The controller is electrically connected to the drive circuit board 12 or assembled on the drive circuit board 12, so that the Hall sensor 30 and the photoelectric sensor 50 are electrically connected to the controller through the drive circuit board 12.

In some embodiments, the electric motor 100 further includes a bearing 60 and a fixed rod 70 matched with the bearing 60. In one embodiment, there are two bearings 60, and the two bearings 60 are stacked in an axial direction. The bearing 60 includes an inner ring 61 and an outer ring 62 that rotates relative to the inner ring 61, the outer ring 62 is fixed to the stator 10, and a center of the outer ring 62 is coaxial with a rotation axis of the stator 10. The fixed rod 70 passes through the rotor end cover and/or the magnet holder 23 of the rotor 20 and is fixed to one or both of them, and then is fixed to the inner ring 61 of the bearing 60, so that the relative rotation between the rotor 20 and the stator 10 can be implemented by the bearing 60, to ensure the smooth rotation of the rotor 20 relative to the stator 10 and avoid abrasion between the rotor 20 and the stator 10.

In the electric motor 100 provided by the present disclosure, the photoelectric sensor 50 and the positioning ring 40 are respectively arranged on the stator 10 and the rotor 20, and the position of the boundary between the first area 41 and the second area 42 of the positioning ring 40 corresponds exactly to the initial position of the electric motor 100, the position of the boundary is the boundary 43. The photoelectric sensor 50 detects whether the photoelectric sensor 50 corresponds to the first area 41 or the second area 42 and sends the obtained area information to the controller. The controller controls, according to the area information, the rotor 20 to rotate in a certain direction relative to the stator 10, so that the photoelectric sensor 50 rotates to the boundary position corresponding to the positioning ring 40 until the photoelectric sensor 50 senses the correspondence to the boundary 43. At this point, the electric motor 100 is at the initial position of the electric motor 100.

The present disclosure also provides a gimbal. The gimbal includes at least one gimbal shaft, the gimbal shaft includes the electric motor 100, and the electric motor 100 is configured to drive the gimbal shaft to rotate. Since the electric motor 100 can determine the initial position of the electric motor simply and quickly, the gimbal can be controlled simply and quickly. In addition, the electric motor 100 of the present disclosure does not need to be provided with a mechanical limit structure to implement positioning. Accordingly, damage to the gimbal can be avoided and the service life of the gimbal can be guaranteed.

The above-disclosed are only the preferred embodiments of the disclosure, and of course the scope of the disclosure cannot be limited by this. Those of ordinary skill in the art can understand all or part of the process for implementing the above-mentioned embodiments and thus the equivalent changes made according to the claims of the present disclosure shall fall within the scope of the disclosure.

What is claimed is:

1. An electric motor positioning device for an electric motor, comprising:
a photoelectric sensor; and
a positioning ring including a first area and a second area,
wherein:
the electric motor comprises a rotor and a stator, the rotor being rotatably mounted on the stator;
one of the photoelectric sensor and the positioning ring is fixed on the rotor and rotates with the rotor, and the other one of the photoelectric sensor and the positioning ring is fixed on the stator; and
a position of the photoelectric sensor relative to the positioning ring rotates within a predetermined range with a relative rotation between the rotor and the stator, the predetermined range including a boundary between a first area and a second area.

2. The electric motor positioning device according to claim 1, wherein the positioning ring is fixed on the rotor, and the photoelectric sensor is fixed on the stator.

3. The electric motor positioning device according to claim 1, wherein:
the photoelectric sensor comprises a light emitting module and a light receiving module, and
the light emitting module and the light receiving module are disposed at a same side of the positioning ring.

4. The electric motor positioning device according to claim 2, wherein a light reflectivity of the first area is different from a light reflectivity of the second area.

5. The electric motor positioning device according to claim 4, wherein the light reflectivity of the first area is greater than the light reflectivity of the second area, and the first area is coated with a light reflective layer.

6. The electric motor positioning device according to claim 1, wherein the photoelectric sensor comprises a light emitting module and a light receiving module, and the light emitting module and the light receiving module are disposed at both sides of the positioning ring.

7. The electric motor positioning device according to claim 6, wherein a light transmittance of the first area is different from a light transmittance of the second area.

8. The electric motor positioning device according to claim 1, wherein the first area and the second area are symmetrically disposed at the positioning ring.

9. An electric motor, comprising:
a stator;
a rotor rotatably mounted on the stator;
a controller; and
an electric motor positioning device, comprising:
a photoelectric sensor electrically connected to the controller, the controller being configured to obtain an electrical signal of the photoelectric sensor; and
a positioning ring including a first area and a second area, wherein:
one of the photoelectric sensor and the positioning ring is fixed on the rotor and rotates with the rotor, and the other one of the photoelectric sensor and the positioning ring is fixed on the stator; and
a position of the photoelectric sensor relative to the positioning ring rotates within a predetermined range with a relative rotation between the rotor and the stator, the predetermined range including a boundary between a first area and a second area.

10. The electric motor according to claim 9, wherein the electric motor further comprises a Hall sensor, the Hall sensor being electrically connected to the controller and being configured to provide information about a rotation angle of the rotor to the controller.

11. The electric motor according to claim 10, wherein:
a drive circuit board is disposed at the stator, and the drive circuit board is electrically connected to the controller; and
the photoelectric sensor and the Hall sensor are disposed at the drive circuit board and are electrically connected to the drive circuit board.

12. The electric motor according to claim 9, wherein:
the rotor comprises a magnet holder and a rotor magnet, the rotor magnet and the positioning ring being both fixed on the magnet holder, and a center of the positioning ring being coaxial with a rotation axis of the rotor; and
a first positioning member is disposed at the magnet holder, a second positioning member is disposed at the positioning ring corresponding to the first positioning member, and the first positioning member and the second positioning member position the positioning ring on the rotor.

13. The electric motor according to claim 12, wherein:
the magnet holder comprises a fixed ring;
a plurality of first protrusions and a plurality of third protrusions are spaced and disposed at a periphery of the fixed ring perpendicular to a plane of the fixed ring, a height of first protrusion being different from a height of third protrusion; and
a plurality of second protrusions and a plurality of fourth protrusions are spaced and disposed at the positioning ring perpendicular to a plane of the positioning ring, a height of the fourth protrusion being different from a height of the second protrusion, the second protrusion being opposite the first protrusion and being fixed to the first protrusion, a fourth protrusion corresponding to a third protrusion, and a sum of the height of the fourth protrusion and the height the third protrusion being same as a sum of the height of the first protrusion and the height of the second protrusion.

14. The electric motor according to claim 9, wherein: the rotor comprises a rotor end cover, the positioning ring being fixed to the rotor end cover; a first positioning member is disposed at the rotor end cover, a second positioning member is disposed at the positioning right corresponding to the first positioning member, and the first positioning member and the second positioning member are configured to position the positioning ring on the rotor.

15. A gimbal, comprising:
at least one gimbal shaft, comprising:
an electric motor configured to drive the gimbal shaft to rotate, the electric motor comprising:
a stator;
a rotor rotatably mounted on the stator;
a controller; and
an electric motor positioning device, comprising:
a photoelectric sensor electrically connected to the controller, the controller being configured to obtain an electrical signal from the photoelectric sensor; and
a positioning ring including a first area and a second area, wherein:
one of the photoelectric sensor and the positioning ring is fixed on the rotor and rotates with the rotor, and the other one of the photoelectric sensor and the positioning ring is fixed on the stator; and
a position of the photoelectric sensor relative to the positioning ring rotates within a predetermined range with a relative rotation between the rotor and the stator, the predetermined range including a boundary between a first area and a second area.
